(19) United States
(12) Patent Application Publication
(10) Pub. No.: US 2006/0080414 A1
(43) Pub. Date: Apr. 13, 2006

(54) System and method for managed installation of a computer network

(75) Inventor: Michael S. Cohen, Middleton, ID (US)

Correspondence Address: John R. Thompson;STOEL RIVES LLP, One Utah Center, 201 South Main Street, Suite 1100, Salt Lake City, UT, 84111, US

(73) Assignee: Dedicated Devices, Inc., Nampa, ID (US)

(21) Appl. No.: 10/889,278

(22) Filed: Jul. 12, 2004

(51) Int. Cl. G06F 15/177

(52) U.S. Cl. 709/220

(57) ABSTRACT

A system includes a portable computer that provides temporary Internet access to a server. The portable computer selects and downloads network applications from one or more support servers. The portable computer installs network applications on the server and associated clients and generates a network model to review the simulated operation of the network applications.

### TECHNICAL FIELD

This invention relates to computer networks and, more specifically, to remote network installations.

### BACKGROUND OF THE INVENTION

A computer network, such as a Local Area Network (LAN) and a Wide Area Network (WAN), provide interconnection between different computer processing nodes. Each computer processing node includes a variety of applications which must be installed to enable network connectivity. One method of installation requires that a network administrator operate each processing node or workstation and manually enter the parameters for each software product which needed to be installed, configured or maintained. With only a few processing nodes, this was not an overwhelming task for an administrator to manually perform installation and configuration of applications.

Manual installation becomes more tedious and prone to error as the number of nodes in a network and the overall complexity increases. Software applications were developed to install network applications on nodes throughout a network. In this manner, network applications may be installed and configured on nodes remotely. Over time, installation applications have become more sophisticated in efficiently distributing, installing and configuring network applications over the network.

Users depend on the reliability and robustness of a network. Accordingly, each node must have its corresponding network applications installed and configured properly. A faulty commercial network will result in errors, downtime, and inefficient performance. A residential network must provide a quality service to the end user who is unlikely to be as sophisticated and able to troubleshoot. Thus, it would be an advancement in the art to increase the efficiency and quality of a network installation.

### BRIEF DESCRIPTION OF THE DRAWINGS

A more particular description of the invention briefly described above will be rendered by reference to the appended drawings. Understanding that these drawings only provide information concerning typical embodiments of the invention and are not therefore to be considered limiting of its scope, the invention will be described and explained with additional specificity and detail through the use of the accompanying drawings, in which:

FIG. 1 is a block diagram of one embodiment of an installation system of the present invention;

FIG. 2 is a block diagram of one embodiment of modules of the present invention; and

FIG. 3 is a flow diagram illustrating one embodiment of a method of the present invention.

### DETAILED DESCRIPTION OF PREFERRED EMBODIMENTS

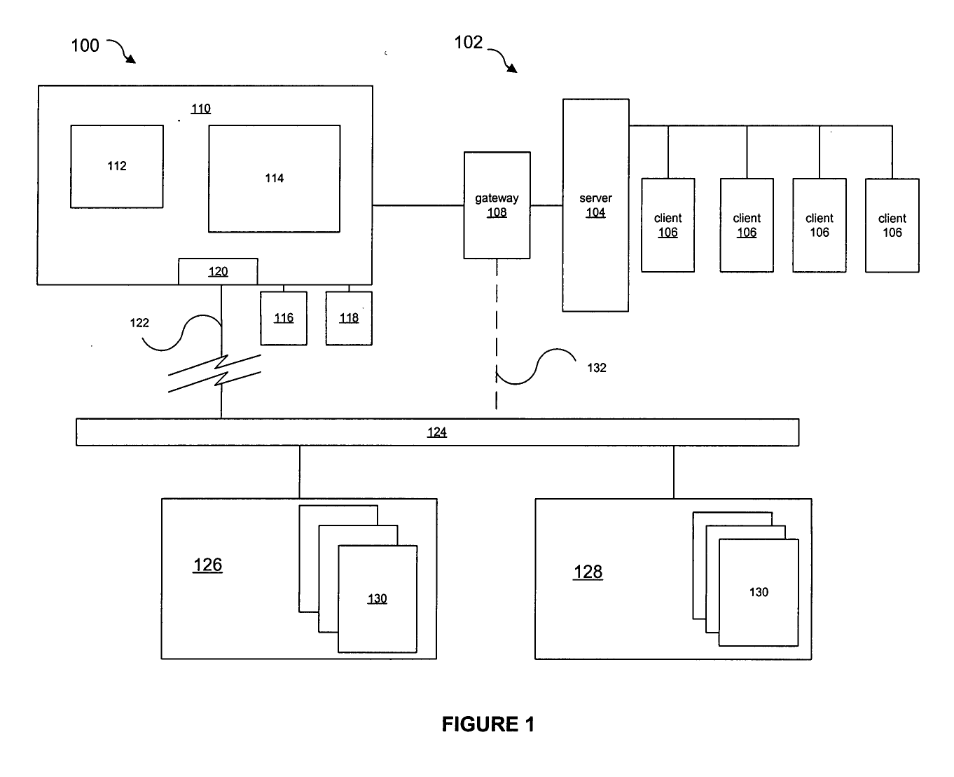

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 3, is not intended to limit the scope of the invention, as claimed, but is merely representative of presently preferred embodiments of the invention.

Specific examples are given to illustrate aspects of the invention, but those of skill in the relevant art(s) will understand that other examples may also fall within the meaning of the terms used, and hence within the scope of one or more claims. Important terms may be defined, either explicitly or implicitly, here in the Detailed Description and/or elsewhere in the application file.

The various modules discussed herein may be, for example, circuits, hardware, software, commands, data files, programs, code, instructions, or the like, or various combinations thereof. Furthermore, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Referring to FIG. 1, a block diagram of system 100 for managing installation of a network 102 is shown. The system 100 supports and verifies installation during an initial building phase, completion phase, and set-up. The system 100 further provides support and verification during subsequent upgrades or service interventions. The system 100 includes modules or applications that are implemented in software program or code that can be stored in a machine-readable medium to permit a computer to perform any of the methods described herein. Suitable software program or code to assist is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

A network 102 suitable for installation and for configuration as described herein may be a local area network and, in some embodiments, may be formed from parts or entireties of two or more other networks, including networks using disparate hardware and network communication technologies. One suitable network includes a server 104 and several clients 106. Other suitable networks may include other combinations of servers, clients, and/or peer-to-peer nodes, and a given computer may function both as a client and as a server. Each network includes at least two processing nodes, such as the server and/or clients.

Each client 106 typically includes a network interface for network connection and an inter-connect/management processor to manage network traffic and identify the client 106 to the server 104. Upon installation, the client 106 is assigned an address or other suitable designation. Power for each client 106 may be received by power-over network, battery, or by connection to standard power distribution lines.

Upon network installation, the server 104 enables network management and connectivity for the network 102. In some embodiments, the server 104 provides centralized storage, distribution, and access to digital content and media. The server 104 may further provide access to external resources, such as the Internet, telephone, cable TV, satellite TV, and the like.

The clients 106 may be embodied as any number of devices including general purpose computers or specific function devices. The clients 106 may be IP enabled and support video/audio applications. In such an implementation, the server 104 may provide digital media content which is streamed to the client 106. A client 106 may be embodied as a digital media adapter for controlling audio/video distribution to stereo and home theater equipment. Through a client adapter, non-IP enabled audio/video equipment has connectivity to the network 102 to receive digital media content. Further client embodiments include automation controllers, such as HVAC control, security system control, and sprinkler controls, health monitors, image sensors, air quality sensors, and water quality sensors. Indeed, a client 106 may include numerous additional devices with processing capability to facilitate a commercial or residential environment.

Physical network communication may be enabled through ethernet, cat-5 cable, wireless, and the like. The installed network 102 may include communications or networking software, such as the software available from Novell, Microsoft, Artisoft, and other vendors, and may operate using TCP/IP, SPX, IPX, and other protocols. The physical network communication may be enabled through ethernet, cat-5, twisted pair, coaxial, optical fiber cables, telephone lines, satellites, microwave relays, modulated AC power lines, and/or other data transmission “wires” known to those of skill in the art. The network may encompass smaller networks and/or be connectable to other networks through a gateway or similar mechanism.

The server 104 is in electrical communication with a gateway 108 to route communication from the network 102 to external destinations. In one implementation, the server 104 and gateway 108 are integrated together. The system 100 includes a general purpose portable computer 110, such as a laptop, handheld computing device, disconnectable mobile computer, and the like. The portable computer 110 monitors the installation status of network applications and provides connectivity to support services.

The portable computer 110 includes a processor 112 and a memory 114 and various input devices 116 and output devices 118. The processor 112 may include a general purpose device, such as a 80×86, Pentium (mark of Intel), 680×0, or other “off-the-shelf” microprocessor. The processor 112 may include a special purpose processing device, such as an ASIC, PAL, PLA, PLD, Field Programmable Gate Array, or other customized or programmable device. The memory 114 may include static RAM, dynamic RAM, flash memory, ROM, CD-ROM, disk, tape, magnetic, optical, or other computer storage medium. The input device(s) 116 may include a keyboard, mouse, touch screen, light pen, tablet, microphone, sensor, or other hardware with accompanying firmware and/or software. The output device(s) 118 may include a monitor or other display, printer, speech or text synthesizer, switch, signal line, or other hardware with accompanying firmware and/or software. The portable computer 110 may be capable of using a floppy drive, tape drive, optical drive, magneto-optical drive, or the like to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices.

The portable computer 110 includes a network port 120 to provide wire or wireless connection 122 to the Internet 124. The connection 122 may be through a wide area network serviced by an ISP or other conventional service. Support servers, such as a manufacturer server 126 and an installation contractor server 128 are in electrical communication with the Internet 124 and host network modules 130 for access and download. The manufacturer server 126 is operated by a manufacturer or service provider for the system 100 and its associated network 102. The installation contractor server 128 is operated by an installer service that performs the network installation. The portable computer 110, in performing an installation, accesses the servers 126, 128, references the network applications 130, and downloads the required network applications 130.

The portable computer 110 is able to provide temporary Internet access for the network 102 prior to establishing a network WAN connection 132. The temporary Internet access through the connection 122 may include temporary security and authentication permissions. The temporary security and permissions are cleared upon completed network installation.

In one embodiment, the portable computer 110 may rely on a physical network WAN connection 132 for communication with the Internet 124. The connection 132, although not yet operable for the network 102, provides WAN and Internet communication for the portable computer 110.

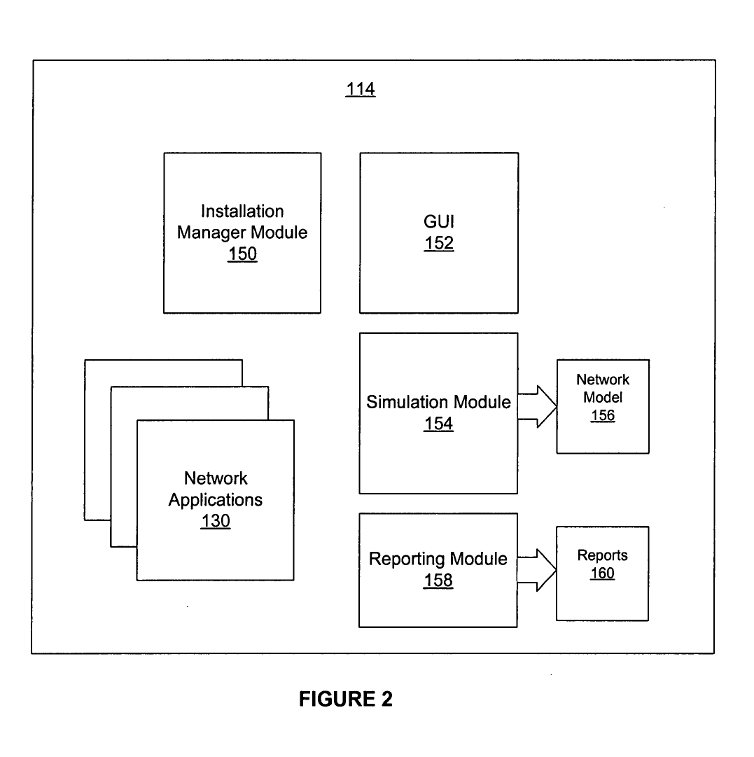

Referring to FIG. 2, a block diagram of modules resident in memory 114 for performing a network installation are shown. The memory 114 includes an installation manager module 150 that installs and configures network applications on the network 102. The installation manager module 150 operates in conjunction with a GUI 152 to prompt for inputs from a network administrator and relay the status of the network installation. The GUI 152 may provide a network administrator with a high level view of the target installation to reduce the amount of physical implementation.

The installation manager module 150 determines which network applications 130 are to be installed and configured on the server 104 and clients 106. The installation manager module 150 initiates a request to the servers 126, 128 for network applications 130. The network applications 130 are transmitted and temporarily stored in the memory 114. The network applications 130 may be transmitted and stored in a compressed and extractable format in order to facilitate transmission.

The memory 114 further includes a simulation module 154 to emulate the network applications 130 in operation on the network 102. The simulation module 154 generates a network model 156 to illustrate the anticipated functionality of the network 102 upon installation. The model 156 simulates performance of a completed network installation and can be compared with a partially installed network 102 to verify status and adherence to a targeted plan. After partial or complete installation, the model 156 may be compared against the current network 102 to determine if additional network applications, updates, or configurations are required. The installation manager module 150 may identify and replace, remove, or update missing, outdated, or dysfunctional network applications 130.

Although the simulation module 154 is illustrated as being resident in the memory 114 of the portable computer 110, it may also be located on a remote processing node (not shown). The remote processing node would be accessible to the portable computer 110 through a WAN or Internet. The installation manager module 150 is able to communicate with the remotely located simulation module 154 and review the generated network model 156.

The simulation module 154 further allows for the emulation of outside service provider applications prior to installation. Prior to establishing third party service connections, the simulation module 154 can emulate proposed applications and tests for proper configuration. If the network model 156 verifies compatibility with a proposed application, the installation manager module 150 confirms its acceptance. The application may then be downloaded and installed on the network 102.

The memory 114 may further include a reporting module 158 that periodically generates automated reports 160 of the network status during installation. The reporting module 158 transmits the reports 160 to one or more servers 126, 128 to allow their monitoring of the installation in progress. Servers 126, 128 review the reports and in response may generate notices or warnings to portable unit 110. A notice may confirm the installation progress, and a warning may raise a concern or flag a problem. The installation manager module 150 reviews responses and may query the servers 126, 128 for further clarification or query the network administrator for authorization.

Network applications 130 may also include optional components which may be installed on the network 102. The installation manager module 150 may query either server 126, 128 to confirm that the optional components are approved and to certify that the installed network complies with technical and licensing requirements. Additional network applications 130 or components that are received from additional sources may also be reviewed and approved by either server 126, 128 prior to installation. A remote server 126, 128 is able to provide a degree of assurance in the approval and compliance of network applications 130.

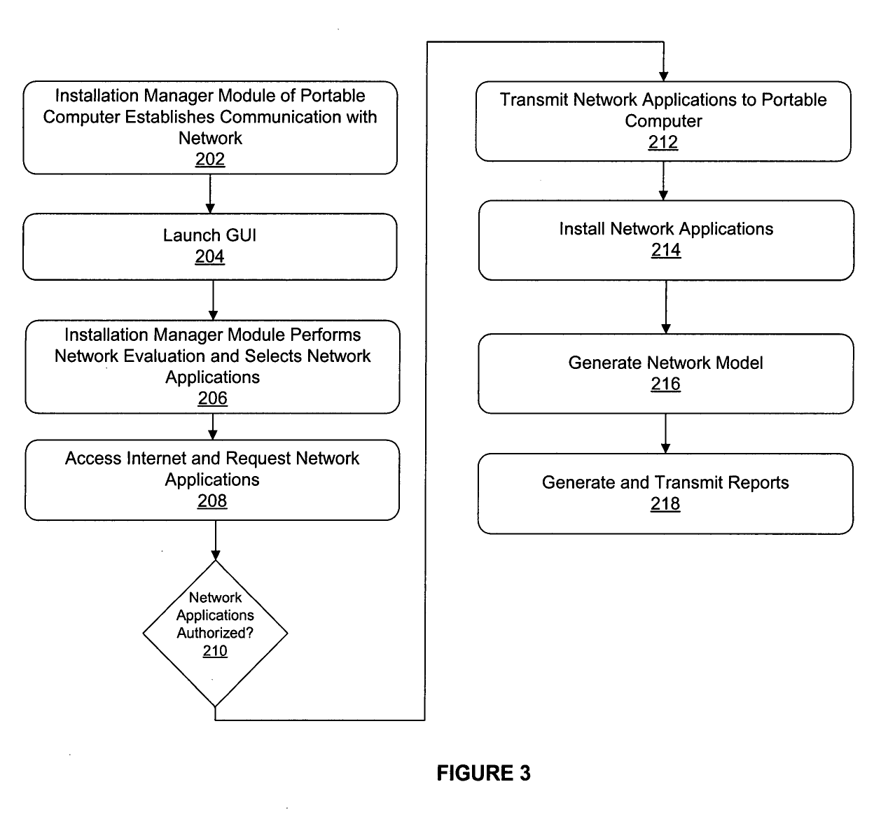

Referring to FIG. 3, a flow diagram 200 of one embodiment of an installation process is shown. As can be appreciated, the flow diagram 200 is provided for illustrative purposes and is not inclusive of all steps that may be performed. Furthermore, one of skill in the art will appreciate that the present invention may be practiced in various ways and is not restricted to the illustrated order. Initially, the installation manager module 150 establishes 202 communication with the server 104 through a conventional protocol. This includes providing a physical communication between the portable computer 110 and the server 104. The installation manager module 150 further launches 204 the GUI 152 to allow user interaction and relay the installation status.

With established communication, the installation manager module 150 performs an initial evaluation 206 of the network 102 to review the hardware components and determines the required network applications 130. The installation manager module 150 accesses 208 the Internet 124 and requests network applications 130 from the servers 126, 128. Alternatively, the portable computer 110 may include some or all of the network applications 130 resident in the memory 114. Additional network applications 130 may be downloaded from servers 126, 128 as needed.

In response to the request, a server 126, 128 may verify authorization 210 based on technical capability and licensing for the network 102 and transmits 212 the requested network applications 130. The installation manager module 150 receives the network applications 130 and installs 214 the network applications 130 on the server 104. The installation manager module 150 receives feedback from the network 102 that there are successful connections with the server 104 and the clients 106. The installation manager module 150 operating in conjunction with the server 104 assigns client identifications. Autodiscovery protocols, such as UpnP, may be used to facilitate identification.

The server 104 further transmits network applications 130 to the clients 106 for installation. The initial setup includes configuring and testing the network applications 130. The installation manager module 150 prompts the simulation module 154 to generate 216 a model 156 of the installed network. The model 156 is used to emulate network applications 130 and verify compatibility. The model 156 may be generated and reviewed at any time during the installation process once proposed network applications 130 have been selected.

During installation, the installation manager module 150 further prompts the reporting module 158 to generate reports of the system status. Servers 126, 128 receive the reports and are able to monitor installation in progress. The servers 126, 128 may respond to the portable computer 110 with notices and warnings as needed.

The present invention has particular application to residential and small commercial networks where standard installation is performed routinely and a full-time network administrator is not supported. Once the hardware and interconnection for a network 102 is installed, a field administrator may be dispatched to install the network installation. A portable computer that supports Internet access, simulated network performance, and service provider downloads and monitoring facilitates installation and enhances reliability of the completed network. The system 100 of the present invention provides an integrated test platform for network installation. A portable computer 110 operates as a field installer and integrates all required test hardware and software either on the portable computer 110 or through communication with additional network resources. Network applications 130 are simulated prior to installation and verified for compliance and performance.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These and other modifications can be made to the invention in light of the above-detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A portable computer for electrically communicating with a server and one or more clients to install network applications, the portable computer comprising:
a processor; and
a memory, in electrical communication with the processor and including, an installation manager module performing the method of,
communicating with the server,
selecting network applications to be installed on the server and clients,
providing communication between the server and an Internet,
accessing a support server over the Internet,
downloading selected network applications from the support server, and
installing the network applications on the server and clients, and a simulation module performing the method of,
generating a network model simulating the operation of the server and clients with installed, selected network applications.

2. The portable computer of claim 1, wherein the memory further includes a GUI to enable user interaction with the installation management module.

3. The portable computer of claim 1, wherein the method performed by the installation management module further includes reviewing the network model to determine suitability of the selected network applications.

4. The portable computer of claim 1, wherein the method performed by the installation management module further includes receiving authorization from the support server for the selected network applications.

5. The portable computer of claim 1, wherein the method performed by the installation management module further includes identifying the server and clients and assigning addresses to the server and clients.

6. The portable computer of claim 1, wherein the memory further includes a reporting module performing the method of generating a report indicative of the installing of the network applications.

7. The portable computer of claim 6, wherein the method performed by the installation management module further includes transmitting the report to the support server and receiving a response from the support server.

8. A computer readable medium having stored thereon computer executable instructions for performing a method for electrically communicating with a server and one or more clients and installing network applications, the method comprising:
establishing communication between a portable computer and a server;
selecting network applications to be installed on the server and clients;
providing communication between the server and an Internet through the portable computer;
accessing a support server over the Internet;
downloading selected network applications from the support server;
installing the network applications on the server and clients; and
generating a network model simulating the operation of the server and clients with installed, selected network applications.

9. The computer readable medium of claim 8, wherein the method further includes generating a GUI to enable user interaction.

10. The computer readable medium of claim 8, wherein the method further includes reviewing the network model to determine suitability of the selected network applications.

11. The computer readable medium of claim 8, wherein the method further includes receiving authorization from the support server for the selected network applications.

12. The computer readable medium of claim 8, wherein the method further includes identifying the server and clients and assigning addresses to the server and clients.

13. The computer readable medium of claim 8, wherein the method further includes generating a report indicative of the installing of the network applications.

14. The computer readable medium of claim 8, wherein the method further includes transmitting the report to the support server and receiving a response from the support server.

15. A method for electrically communicating with a server and one or more clients and installing network applications, comprising:
establishing communication between a portable computer and a server;
selecting network applications to be installed on the server and clients;
the portable computer providing communication between the server and an Internet;
accessing a support server over an Internet;
downloading selected network applications from the support server;
installing the network applications on the server and clients; and
generating a network model simulating the operation of the server and clients with installed, selected network applications.

16. The method of claim 15 further comprising, generating a GUI to enable user interaction.

17. The method of claim 15 further comprising, reviewing the network model to determine suitability of the selected network applications.

18. The method of claim 15 further comprising, receiving authorization from the support server for the selected network applications.

19. The method of claim 15 further comprising, identifying the server and clients and assigning addresses to the server and clients.

20. The method of claim 15 further comprising, generating a report indicative of the installing of the network applications.

21. The method of claim 20 further comprising, transmitting the report to the support server and receiving a response from the support server.
